(19) United States
(12) Patent Application Publication
(10) Pub. No.: US 2007/0195042 A1
(43) Pub. Date: Aug. 23, 2007

(54) Liquid Crystal Display Device

(75) Inventor: Barry Mos, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,789

(22) PCT Filed: Apr. 4, 2005
(86) PCT No.: PCT/IB05/51105

§ 371 Date: Oct. 10, 2006

(30) Foreign Application Priority Data
Apr. 13, 2004 (EP) 04101492.9

(51) Int. Cl. G09G 3/36

(52) U.S. Cl. 345/90

(57) ABSTRACT

The present invention relates to an in-plane switching liquid crystal display device. In order to enhance the switching characteristics of the display and to improve contrast in displayed images, each pixel area on a substrate in the display is surrounded by strips of resistive material. By applying driving signals to at least three connection terminals, connected to the resistive material strips at different locations, an electric field may be obtained that is homogenous over the pixel area and that may be changed dynamically during the switching process in order to exert maximum torque on liquid crystal molecules in the pixel throughout the switching process.

### FIELD OF THE INVENTION

The present invention relates to a liquid crystal display device, comprising a liquid crystal material, disposed between first and second substrates, a plurality of individually controllable picture elements, each picture element comprising electric field generating means for generating electric fields in more than one direction in order to influence the liquid crystal material in the picture element.

### BACKGROUND OF THE INVENTION

Such a device, using two straight and one L-shaped electrode, is disclosed in WO, 03/012537, A1. This configuration may be used to increase the rotational speed of the liquid crystal molecules in a pixel, and therefore to increase the switching speed of the LCD-display, since in average a greater torque may be provided to each liquid crystal molecule during the switching procedure. However, such a display device may be impaired by contrast and brightness disturbances, particularly in the corners of a pixel.

### SUMMARY OF THE INVENTION

It is an object of the present invention to provide a display device of the above mentioned type with improved contrast and/or brightness properties.

This object is achieved by means of a display device according to claim 1.

More specifically, a liquid crystal display device according to an aspect of the invention, comprises a liquid crystal material, disposed between first and second substrates, a plurality of individually controllable picture elements, each picture element comprising electric field generating means for generating electric fields in more than one direction in order to influence the liquid crystal material in the picture element, wherein said electric field generating means comprises resistive material layer paths, disposed on said first substrate and substantially surrounding the area of the picture element, and at least three connection terminals for feeding voltage to the resistive material layer paths.

This allows the electric field to exert a strong torque on the liquid crystal molecules during the switching process, which makes the switching process fast. The resistive paths allow, unlike the conductive electrodes in the prior art, a potential drop along their lengths. Therefore, the resistive path disturbs an electric field much less than a conductive electrode would do, provided that it is not perpendicular to the electric field. This leads to a more uniform electric field, and consequently a more uniform polarization of the liquid crystal material over the pixel area. The more uniform polarization provides improved contrast and brightness properties for the pixel and thus for the display.

In a preferred embodiment the resistive material layer paths form a continuous layer, surrounding the area defined by the picture element. This allows an electric field to be generated with virtually any angle in the plane of the substrate, and with relatively few connection terminals.

Preferably, the resistive material layer paths comprise strips, which form a rectangle and the picture element comprises four connection terminals, attached to the corners of said rectangle. This embodiment is compatible with most types of displays having arrays of pixels arranged in rows and columns.

In alternative embodiments however, the resistive material layer path comprise strips, which may form a triangle, where the picture element comprises three connection terminals, attached to the corners of the triangle, or a hexagon with three connection terminals, attached to every second corner of the hexagon.

In a preferred embodiment the display device with rectangular pixels comprises driving means, adapted to feed a first voltage in relation to earth to a connection terminal at a first corner, a second voltage to a connection terminal at a second corner, which is antipodal to the first corner, and to feed voltages between said first and second voltage to the contact terminals at the intermediate third and fourth corners. This allows the generation of a field that is oblique in relation to the pixel geometry and that still is homogenous.

In a preferred embodiment, the display device comprises an orientation layer, allowing the liquid crystal molecules of the liquid crystal material to rotate freely as long as the molecules extend substantially in a plane that is parallel to said first and second substrates. A display device with such electric field generating means and such an orientation layer may be bi-stable, i.e. the molecules of the liquid crystal material may remain optionally in more than one state, without any applied field.

These and other aspects of the invention will be apparent from and elucidated with reference to the embodiments described hereinafter.

### BRIEF DESCRIPTION OF THE DRAWINGS

FIG. 1 illustrates schematically in a perspective view the working principle of a pixel in a conventional IPS liquid crystal display.

FIG. 2 illustrates a top view of the electric field generating means in a first embodiment of the invention.

FIGS. 3a-3d illustrate the working principle of the field generating means in FIG. 2.

FIGS. 4a-4c illustrate a performed simulation and correspond to FIGS. 3a-3c, respectively.

FIG. 5 illustrates schematically a driving circuit for an IPS pixel.

FIGS. 6 to 8 illustrate alternative layouts for electric field generating means in a pixel.

### DESCRIPTION OF PREFERRED EMBODIMENTS

Liquid crystal displays (LCDs) may be used as television screens, personal computer monitors, mobile phone displays etc. An LCD comprises a large number of individually controllable picture elements, hereinafter called pixels, arranged in an array. By controlling the light flow through each pixel, the LCD display may provide an image that may be viewed by a user

FIG. 1 illustrates schematically the working principle of a pixel in a conventional IPS liquid crystal display.

In the off-state, incoming light 1 passes through a first polarizer 2 having a first polarizing direction and becomes polarized accordingly. The polarized light then passes through a liquid crystal material 3 contained between a first and a second transparent glass substrate 4, 5. In the dark off-state, the polarizing direction of the liquid crystal material 3 is such, that the polarizing direction of the light passing therethrough remains unchanged. Therefore, the light is then blocked by a second polarizer 6, having a second polarizing direction at right angle with the polarizing direction of the first polarizer 2.

In the light on-state however, the polarizing direction of the liquid crystal material 3 is such that the polarization direction of the light is rotated 90° when passing through the liquid crystal material 3. The light may therefore subsequently pass through the second polarizer 6. Thus it is possible to modulate the light flow through the pixel by changing the polarization direction of the liquid crystal material 3. This is achieved by generating an electric field between a first 7 and a second 8 conductive electrode on the first substrate 4. When a voltage V₁-V₂ is applied between the first and the second electrode 7, 8, the liquid crystal molecules are forced to rotate into the on-state. When the electric field is released, an orientation layer (not shown) slowly rotates the liquid crystal molecules back into the off-state.

In an in-plane switching (IPS) liquid crystal display, the polarization direction of the liquid crystal molecules rotate in a plane that is parallel to the first and second substrates 4, 5. Therefore, the applied electric field is parallel with the substrates 4, 5 as well.

The torque exerted on a liquid crystal molecule depends on the angle θ between the direction of the electric field and the direction of the liquid crystal molecule, which is elongated. For a liquid crystal material having a negative dielectric anisotropy, the torque is proportional to sin(2θ). Therefore, the maximum torque is exerted when θ is equal to 45°. In the conventional IPS liquid crystal display, this angle is close to 45° only during a short part of the on-switching process. This means that the on-switching process is slow. Moreover, during the off-switching process the conventional display relies on the orientation layer for rotating the molecules back, which makes the off-switching process even slower.

If, however, the electric field can be changed dynamically throughout the switching process of the pixel in such a way that θ is always kept close to 45°, it is possible to substantially improve the switching characteristics of a display device. Moreover, if the electric field can be used in order to at least partly rotate the molecules back from the on-state to the off-state, also this process can be substantially faster.

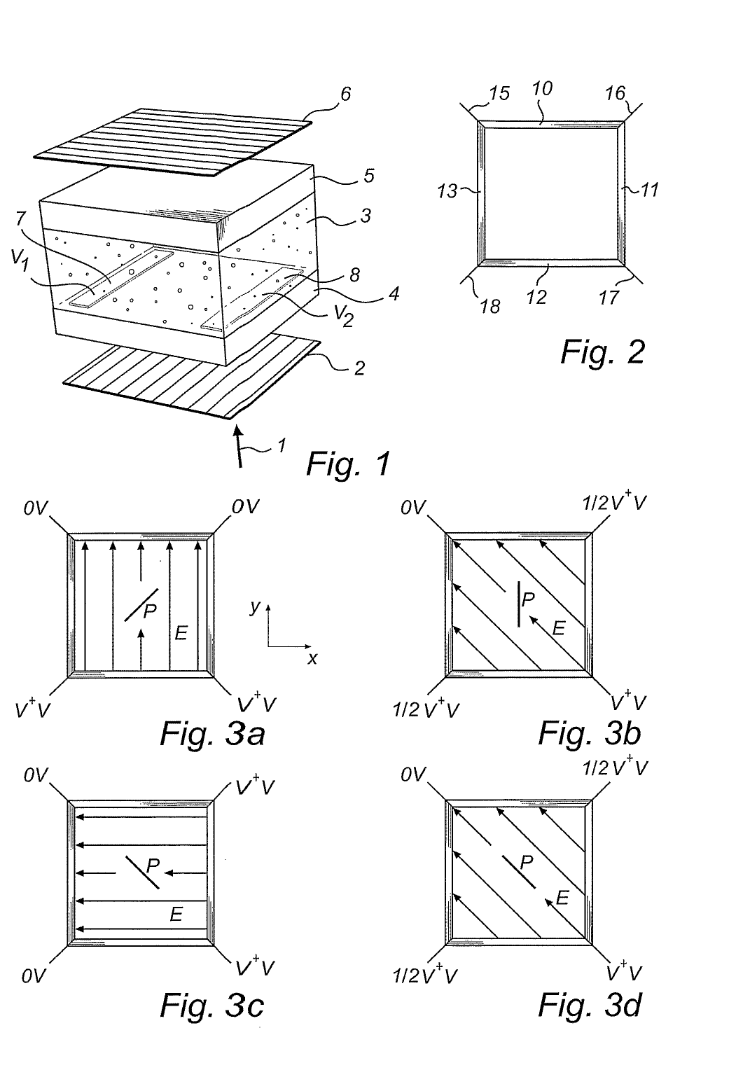

FIG. 2 illustrates electric field generating means in an in-plane switching display device pixel according to an embodiment of the invention. In this embodiment, a pixel area on a substrate is surrounded by resistive paths, preferably in the form of strip elements 10, 11, 12, 13, disposed on the substrate. These resistive elements 10, 11, 12, 13 can thus replace the conductive electrodes 7, 8 in FIG. 1. The strip elements 10, 11, 12, 13 are arranged in a rectangular form, or more specifically a quadratic form. In this embodiment each pixel has four connection terminals 15, 16, 17, 18, or connections, each being capable of feeding a voltage to end points of two resistive strip elements. E.g. the first connection terminal 15 is capable of feeding a voltage to the left end point (as seen in the drawing) of the first resistive strip element 10 and the top end point of the fourth resistive strip element 13. The resistive strip elements 10, 11, 12, 13 can be used to generate an electric field within the pixel area. Since a potential gradient is possible along a resistive element, unlike along a conductive electrode as in the known art, two important advantages may be identified as compared to the known art. Firstly, it is possible, as will be illustrated below, to generate an electric field that is oblique in relation to the directions in which the electric field generation means extend. Secondly, a resistive strip that is placed in an electric field will not disturb this field as much as a corresponding conductive strip.

As will be illustrated below the electric field generating means illustrated in FIG. 2 may be used to achieve a very homogenous field, which may be directed in various angles in relation to the pixel. This allows not only faster on-switching of a pixel, but perhaps more important also faster off-switching of a pixel. This provides e.g. a television set, comprising an LCD display with such pixels, with improved characteristics.

It is preferred, as illustrated in FIG. 2, to let the resistive strip elements 10, 11, 12, 13 entirely surround the pixel area in a continuous layer, but small gaps could be allowed by introducing more connection terminals.

FIGS. 3a-3d illustrate the working principle of the field generating means in FIG. 2. It is assumed in FIG. 3a that the orientation of the liquid crystals and consequently their polarization direction P make a 45° angle with the indicated x-axis. The polarizers (below and above the substrate) make 45° angles with respect to the x-axis, one polarizing direction perpendicular to the other. In this state, the liquid crystal material of the pixel does not turn the polarization of incoming light, and hence the pixel is dark. The connection terminals 15, 16, 17, 18 has just received voltages that will begin to rotate the rotate the liquid crystal molecules out of the dark off-state. The off-state may have been obtained by directing an electric field at 45° to the x-axis, or using an orientation layer, anchoring the molecules in this direction.

On the first and second connection terminals 15, 16 a potential 0V is applied, while the third and fourth connection terminals 17, 18 receive a potential V⁺V (e.g. 10 V). Therefore, the first resistive strip element 10 is, as a whole, on the potential 0V, whereas the third resistive strip element 12 as a whole is on the potential V⁺V. The second and fourth resistive elements 11, 13 experience a potential gradient along their lengths, which is the same gradient as that the liquid crystal material is experiencing. Therefore, the electric field lines are not disturbed, as would be the case with a conductive electrode, and a homogeneous electric field and consequently a homogeneous reorientation of the liquid crystal over the entire width of the pixel is the result. Note that the electric field is making a 45° angle with the polarization direction of the liquid crystals, causing maximum torque.

In FIG. 3b, the liquid crystal molecules have begun to rotate, and are oriented parallel to the y-axis. If the electric field now would have been the same as in FIG. 3a, the liquid crystal molecules would stop their rotation. Now however, the driving potentials of the second and third connection terminals 16, 18 have been changed, the second terminal 16 from 0V to V⁺/2V and the fourth connection terminal 18 from V⁺V to V⁺/2V. The first and third connection terminals 15, 17 receive the same driving potentials as in FIG. 3a. In this state, all resistive strip elements 10, 11, 12, 13 experience a potential gradient, and the electric field, applied over the whole pixel area, has a direction corresponding to 135° to the x-axis. Thus, maximum torque is still obtained.

In FIG. 3c the liquid crystal molecules have rotated still a bit further. If the driving potentials would remain the same as in FIG. 3b, the liquid crystal molecules would continue to rotate towards the angle 135° to the x-axis (where the light state is obtained), but at a decreasing speed. Therefore, in FIG. 3c, the potentials of the second and fourth connection terminals are changed again, the second terminal 16 from V⁺/2V to V⁺V and the fourth connection terminal 18 from V⁺/2V to 00V. The second and fourth resistive elements 11, 13 now have uniform potentials, while the first and third resistive elements 10, 12 have potential gradients. The electric field is parallel with the x-axis and the torque is close to maximum.

When the liquid crystal molecules make an angle of 135° with the x-axis, the potentials are swiftly changed back to the state of FIG. 3b in order to stop the liquid crystal molecules from rotating too far, as indicated in FIG. 3d. Switching the pixel off is carried out in a similar way. The connection terminals could then be switched to the state in FIG. 3b in order to make the molecules start their rotation. The later part of the off-state rotation process can be obtained using a field directed in a corresponding manner towards the x-axis, or by using an orientation layer. A plurality of different switching schemes could be used in order to obtain desired rotational patterns for the liquid crystal material.

The voltages of the connection terminals may be changed discontinuously, e.g. from the state in FIG. 3b to the state in FIG. 3c. However even better performance can be achieved, at the cost of higher complexity, if the driving signals are changed smoothly from one state to the next. It is also possible to change the voltages in any number of substeps as a compromise.

Different combinations using both actively applied electric fields and orientation layers are possible.

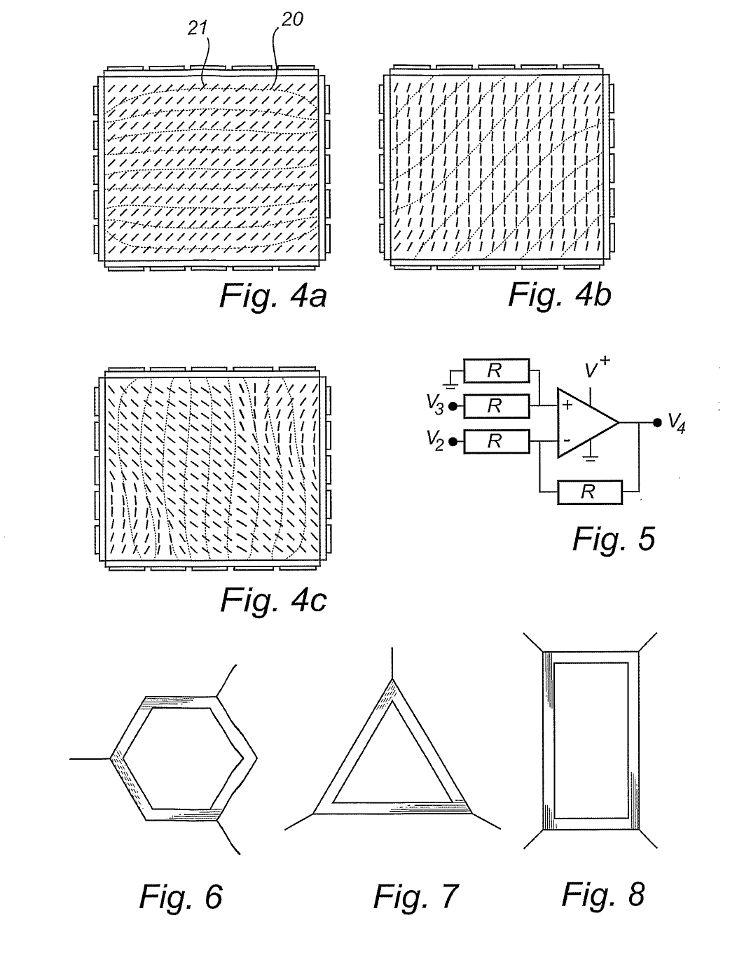

FIGS. 4a-4c illustrate a performed simulation and correspond to 3a-3c, respectively. The simulation has been carried out using the 2dimMOS™ software. The resistive elements have been simulated stepwise, i.e. as a number of conductive element segments, interconnected by means of resistors. Isopotential lines 20 (dashed, perpendicular to the electric field) and representations of the orientation of liquid crystal molecules 21 are shown in FIGS. 4a-4c.

As can be seen in FIGS. 4a-4c, the isopotential lines are evenly distributed over the pixel. The small disturbances that can be seen are caused by the step-wise resistive element simulation approach, and do not occur in a real display where truly resistive elements are used.

The resistive elements may preferably be formed of thin film resistors. Transparent ITO (Indium Tin Oxide) or non-transparent Nickel-Chromium are preferred materials, since they are highly resistive. This minimizes power consumption (low currents) and hence the heating. Use of other materials having these properties is of course possible.

If it is possible that the liquid crystal molecules on top of the resistive elements are oriented in the same way as the molecules in the space between the resistive elements, ITO may be preferred. If however the liquid crystal material on top of the resistive elements is disoriented and could cause false polarization, Nickel-Chromium could be preferred in order to block light that could otherwise be polarized in the wrong way. This enhances the contrast, but of course the aperture is somewhat smaller. The width and thickness of the resistive elements should be chosen so as to be small enough to create a high resistance, but small enough not to result in considerable RC switching times. In an example, the thickness of the resistive strip, when using oxygen enriched ITO, may be 25 nm, the width of the strip may be 12 nm.

The orientation layers of the display device may be arranged to orientation the liquid crystal material, in the absence of any field emitted by the field generating means, in the direction indicated in FIG. 2a (45° angle to the x-axis). In such a display the pixels are switched off when no driving signals are applied to the connection terminals.

However, in an alternative embodiment, the orientation layers may allow the liquid crystal material to rotate freely in the x-y-plane, as long as the orientation is perpendicular to the z-axis. This allows the provision of a bi-stable display, where the liquid crystal material remains in the off-state or on-state until new driving signals are applied to the connection terminals. This allows a lower energy consumption, which is desirable in mobile, battery operated applications. In this case the electric field generating means must be operable to generate fields in the entire angle range between the off-state and the on-state (as determined by the polarizing layers). Preferably fields should also be generated up to 45° outside this range in order to provide optimal switching speed.

Of course the liquid crystal material may also be driven to any intermediate “grey” state, resulting in an n-stable display device.

A display device comprising pixels having the electric field generating arrangement illustrated in FIG. 2 may be applied in different kinds of LCD displays, such as active matrix displays, where each pixel comprises switching means for continuously changing pixel content, or passive matrix displays, where pixel content is updated at regular intervals.

Individual pixels, arranged in a matrix, may be addressed e.g. by connecting the third connection terminal 17 in FIG. 2 to a common row line and connecting the second connection terminal 16 to a common column line. The pixel will then only be activated when the common row line and the common column line are activated simultaneously, thus allowing the addressing of an individual pixel.

FIG. 5 illustrates schematically a driving circuit for an IPS pixel allowing this to be carried out. In an embodiment the potential V₄ for the fourth connection terminal 18, in FIG. 2 is derived from that of the second connection terminal (V₂) 16 by: V₄=V₃−V₂. Note in FIGS. 3a-3d that V₃ for the third connection terminal is always kept at V⁺V and that V₁ for the first connection terminal is always kept at 0V.

This can be accomplished by a simple circuit of resistors and a differential amplifier as illustrated in FIG. 5. The circuit can be made by using a conventional photolithography process. This circuit allows the local generation of all driving voltages using only one connection, i.e. that of the second connection 16. The voltages V⁺ and 0V can be used as a power source for the differential amplifier. All potential combinations in FIGS. 3a-3d can be accomplished using such a driving circuit, and fields between 90-180′ from the x-axis may be generated. When the field is switched off, the liquid crystal material becomes angled at 45° to the x-axis using an orientation layer.

FIGS. 6 to 8 illustrate alternative layouts for electric field generating means in a pixel. FIG. 6 illustrates a case where the resistive material layer strips form a hexagon and where the pixel comprises three connection terminals, attached to every second corner of the hexagon. In FIG. 7, the resistive material layer strips form a triangle and the pixel comprises three connection terminals, attached to the corners of the triangle. FIG. 8 illustrates that, although the quadratic embodiment in FIG. 2 is preferred in many cases, also other rectangular embodiments are conceivable.

In summary, the invention relates to an in-plane switching liquid crystal display device. In order to enhance the switching characteristics of the display and to improve contrast in displayed images, each pixel area on a substrate in the display is surrounded by strips of resistive material. By applying driving signals to at least three connection terminals, connected to the resistive material strips at different locations, an electric field may be obtained that is homogenous over the pixel area and that may be changed dynamically during the switching process in order to exert maximum torque on liquid crystal molecules in the pixel throughout the switching process.

The invention is not restricted to the described embodiment. It can be altered in different ways within the scope of the appended claims. For example, the field generating means may be disposed on either substrate.

The above embodiments are described in connection with a backlighted display. However, a reflective display having such electric field generating means is equally possible.

1. A liquid crystal display device, comprising a liquid crystal material (3), disposed between first and second substrates (4, 5), a plurality of individually controllable picture elements, each picture element comprising electric field generating means for generating electric fields in more than one direction in order to influence the liquid crystal material (3) in the picture element, wherein said electric field generating means comprises resistive material layer paths (10, 11, 12, 13), disposed on said first substrate (4) and substantially surrounding the area of the picture element, and at least three connection terminals (15, 16, 17, 18) for feeding voltage to the resistive layer material paths (10, 11, 12, 13).

2. A liquid crystal display device according to claim 1, wherein the resistive material layer paths form a continuous layer (10, 11, 12, 13), surrounding the area defined by the picture element.

3. A liquid crystal display device according to claim 1, wherein the resistive material layer paths comprise strips (10, 11, 12, 13), which form a rectangle, and the picture element comprises four connection terminals, attached to the corners of said rectangle.

4. A liquid crystal display device according to claim 1, wherein the resistive material layer paths comprise strips, which form a triangle, and the picture element comprises three connection terminals, attached to the corners of said triangle.

5. A liquid crystal display device according to claim 1, wherein the resistive material layer paths comprise strips, which form a hexagon, and the picture element comprises three connection terminals, attached to every second corner of said hexagon.

6. A liquid crystal display device according to claim 3, comprising driving means adapted to feed a first voltage to a connection terminal (15) at a first corner, a second voltage to a connection terminal (17) at a second corner, which is antipodal to the first corner, and to feed voltages between said first and second voltages to the contact terminals (16, 18) at the intermediate third and fourth corners.

7. A liquid crystal display device according to claim 1, comprising an orientation layer, allowing the liquid crystal molecules of the liquid crystal material to rotate freely as long as the molecules extend substantially in a plane that is parallel to said first and second substrates (4, 5).
